(19) United States
(12) Patent Application Publication
(10) Pub. No.: US 2020/0122514 A1
(43) Pub. Date: Apr. 23, 2020

(54) PNEUMATIC TIRE

(71) Applicant: Toyo Tire Corporation, Itami-shi (JP)

(72) Inventor: Toshihiko Kanamura, Itami-shi (JP)

(73) Assignee: Toyo Tire Corporation, Itami-shi (JP)

(21) Appl. No.: 16/591,981

(22) Filed: Oct. 3, 2019

(30) Foreign Application Priority Data
Oct. 22, 2018 (JP) 2018-198694

(51) Int. Cl. B60C 11/03; B60C 11/13; B60C 11/12

(52) U.S. Cl. CPC B60C 11/0304; B60C 11/1353; B60C 11/125; B60C 2011/1361; B60C 2011/0365; B60C 2011/0369; B60C 11/1259

(57) ABSTRACT

A tire has a lug, a sipe and a recessed region. The sipe having an opening sidewall extending in a vertical direction. The recessed region that is formed to either side in a width direction of the sipe. The recessed region has a vertical face that forms a first edge, and has a planar base that intersects the opening sidewall of the sipe. The planar base and the opening sidewall of the sipe forming a second edge at which the angle between the planar base and the opening sidewall is not greater than 90°. Difference in height in the vertical direction of the first edge and the second edge is greater than or equal to 0.5 mm but is less than or equal to 1.5 mm. Distances to the first edge and the second edge in the width direction of the sipe are not less than 1.5 mm.

### BACKGROUND OF THE INVENTION

The present disclosure relates to a pneumatic tire.

It is desired that studless tires, all-season tires, and other such winter tires have improved performance on snowy road surfaces. Among the various performance categories, improvement in performance with respect to traction in snow is desired.

Japanese Patent Application Publication Kokai No. 2001-187517 discloses formation of zigzag-shaped sipes at the base of lug grooves to improve snow performance and dry performance.

Japanese Patent Application Publication Kokai No. 2004-330812 discloses formation of a widened portion at an opening of a sipe to improve wet performance and suppress uneven wear.

While there is a description in Japanese Patent Application Publication Kokai No. 2001-187517 to the effect that the lug groove permits attainment of snow traction, new techniques for attainment of snow traction are desired.

### SUMMARY OF THE INVENTION

It is an object of the present disclosure to provide a pneumatic tire permitting improvement in performance with respect to traction in snow.

According of the present disclosure, there is provided a pneumatic tire comprising:

a lug that is partitioned by at least one major groove and that forms a contact patch surface;

a sipe that extends from the at least one major groove so as to be directed toward a center in a tire width direction of the lug, the sipe having an opening sidewall extending in a vertical direction; and

a recessed region that is thrilled to either side in a width direction of the sipe and that is recessed relative to the contact patch surface;

wherein the recessed region has a vertical face that forms a first edge between the vertical face and the contact patch surface, and has a planar base that intersects the opening sidewall of the sipe, the planar base and the opening sidewall of the sipe forming a second edge at which the angle between the planar base and the opening sidewall is not greater than 90°;

wherein difference in height in the vertical direction of the first edge and the second edge is greater than or equal to 0.5 mm but is less than or equal to 1.5 mm; and

wherein distances to the first edge and the second edge in the width direction of the sipe are not less than 1.5 mm.

Thus, recessed region is formed to either side in the width direction of sipe formed at lug, recessed region being formed from vertical face and planar base. Because first edge is formed between contact patch surface and vertical face that extends in parallel fashion with respect to the vertical direction which is parallel to the tire radial direction, an edge effect due to action by first edge is exhibited.

Furthermore, because second edge is formed between planar base and opening sidewall sipe, and because angle of second edge is not greater than 90°, an edge effect due to action by second edge is exhibited. Moreover, because difference in the height in vertical direction of first edge and second edge is not greater than 1.5 mm, and because distances to first edge and second edge in the width direction of sipe are not less than 1.5 mm, it will be the case that deformation by lug when acted upon by a load will cause second edge to be made capable of coming in contact with the ground, as a result of which it will be possible to obtain a doubling of edge effect due to action by first edge and second edge, and it will be possible to improve performance with respect to traction in snow. Because difference in the height in the vertical direction of first edge and second edge is not less than 0.5 mm, it will be possible to obtain an edge effect due to action by first edge.

### BRIEF DESCRIPTION OF THE DRAWINGS

FIG. 1 Plan view showing tread pattern in accordance with a first embodiment

FIG. 2A Plan view showing lug in which recessed regions and sipes are formed

FIG. 2B Drawing showing projection in the tire width direction of the shape of a sipe at a central portion in the width direction of the sipe

FIG. 3A Sectional view taken along section A1-A1 in FIG. 2A

FIG. 3B Sectional view taken along section A2-A2 in FIG. 2A

FIG. 4A Tire meridional section of lug

FIG. 4B Tire meridional section of a lug in accordance with a variation

FIG. 5 Sectional view taken along section A1-A1 in accordance with a variation

FIG. 6 Plan view showing lug in which recessed regions and sires are formed in accordance with a variation

FIG. 7A Sectional view taken along section A1-A1 in accordance with a variation

FIG. 7B Sectional view taken along section A1-A1 in accordance with a variation

### DETAILED DESCRIPTION OF THE PREFERRED EMBODIMENTS

### First Embodiment

Below, a first embodiment in accordance with the present disclosure is described. In the drawings, “CD” refers to the tire circumferential direction, and “WD” refers to the tire width direction. The respective drawings show shapes as they would exist when the tire is still new.

While not shown in the drawings, a pneumatic tire in accordance with the first embodiment, in similar fashion as with an ordinary pneumatic: tire, is provided with a pair of bead cores; a carcass that wraps around the head cores in toroidal fashion; a belt layer arranged toward the exterior in the tire radial direction from a crown region of the carcass; and a tread region arranged toward the exterior in the tire radial direction from the belt layer.

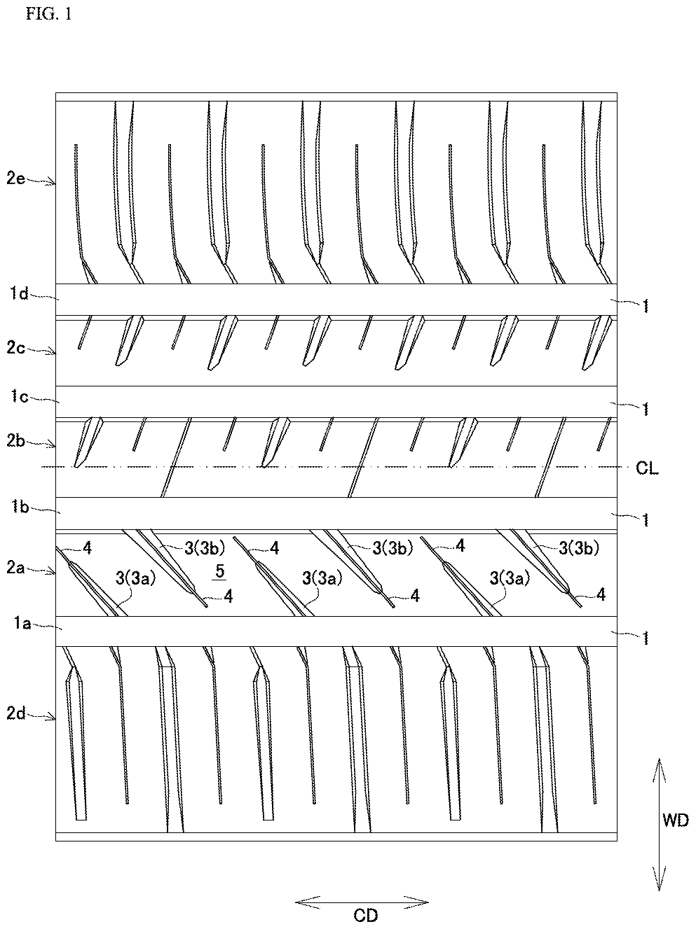

As shown in FIG. 1, the tread region has a plurality of major grooves 1 (1a, 1b, 1c, 1d) extending in the tire circumferential direction CD, and lug 2a that is partitioned by two major grooves 1a, 1b and that forms contact patch surface 5. The tread region also has lug 2b that is partitioned by two major grooves (1b, 1c) and that is arranged at the tire equator CL; lug 2c that is partitioned by two major grooves (1c, 1d); and lug 2d [2e] that is partitioned by major groove 1a [1d] which is outwardmost in the tire width direction WD. So long as they extend in the tire circumferential direction, the major grooves may coincide with the tire circumferential direction or may be inclined with, respect thereto, and/or may be zigzag-shaped. The number of major grooves that are present may be varied as appropriate. Whereas in the present embodiment there are four major grooves arranged so as to avoid tire equator CL, there is no limitation with respect thereto. For example, the present disclosure may also be understood to apply to the situation in which a lug is partitioned by a first major groove that is arranged on tire equator CL and a major groove.

Contact patch surface 5 refers to the surface that contacts the road surface when a tire inflated to normal internal pressure mounted on a normal rim and bearing a normal load is disposed in perpendicular fashion above a flat road surface. A normal rim is that particular rim which is specified for use with a particular tire in the context of the body of standards that contains the standard that applies to the tire in question. This is referred to as a “standard rim” in the case of JATMA, as a “design rim” in the case of TRA, and as a “measuring rim” in the case of ETRTO.

Normal internal pressure is that air pressure which is specified for use with a particular tire in the context of the body of standards that contains the standard that applies to the tire in question. This is referred to as “maximum air pressure” in the case of JATMA, the maximum value listed in the table entitled “Tire Load Limits at Various Cold Inflation Pressures” in the case of TRA, and as “inflation pressure” in the case of ETRTO, which when the tire is to used on a passenger vehicle is taken to be an internal pressure of 180 KPa.

Normal load is that load which is specified for use with a particular tire in the context of the body of standards that contains the standard that applies to the tire in question. This is referred to as “maximum load capacity” in the case of JATMA, the maximum value listed in the aforementioned table in the case of TRA, and as “load capacity” in the case of ETRTO, which when the tire is to be used on a passenger vehicle is taken to be 85% of the load corresponding to an internal pressure of 180 KPa.

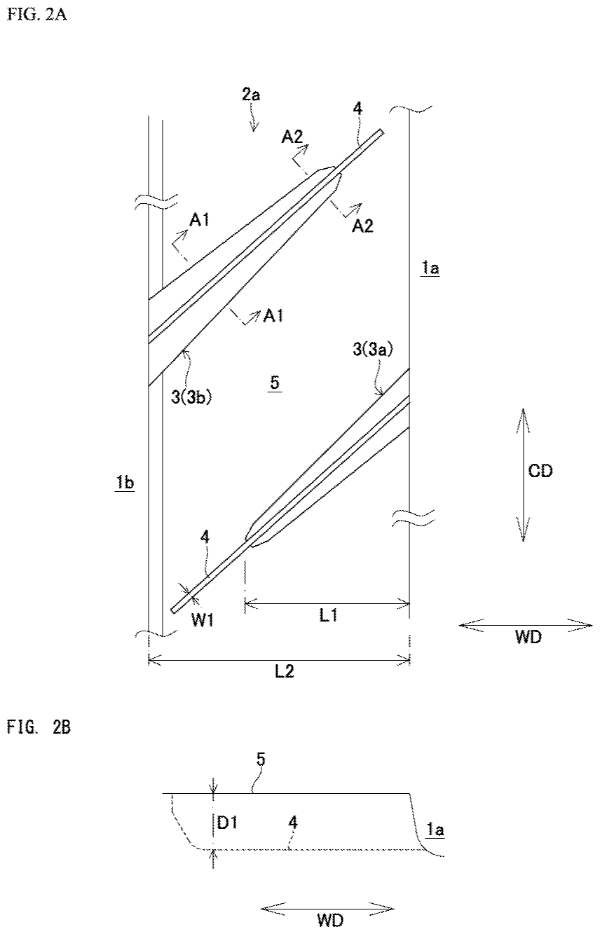

As shown in FIG. 1 and FIG. 2A, formed at lug 2a are sipes 4 that extend from one of two major grooves 1a, 1b so as to be directed toward the center in the tire width direction of lug 2a. As shown in FIG. 2A, it is preferred that width W1 of sipe 4 be 0.3 mm to 1.2 mm. FIG. 2B is a drawing showing the projection in the tire width direction WD of the shape of sipe 4 at the center in the width direction of sipe 4. As shown in FIG. 2B, it is preferred that depth D1 of sipe 4 be 2 mmm to 7 mm.

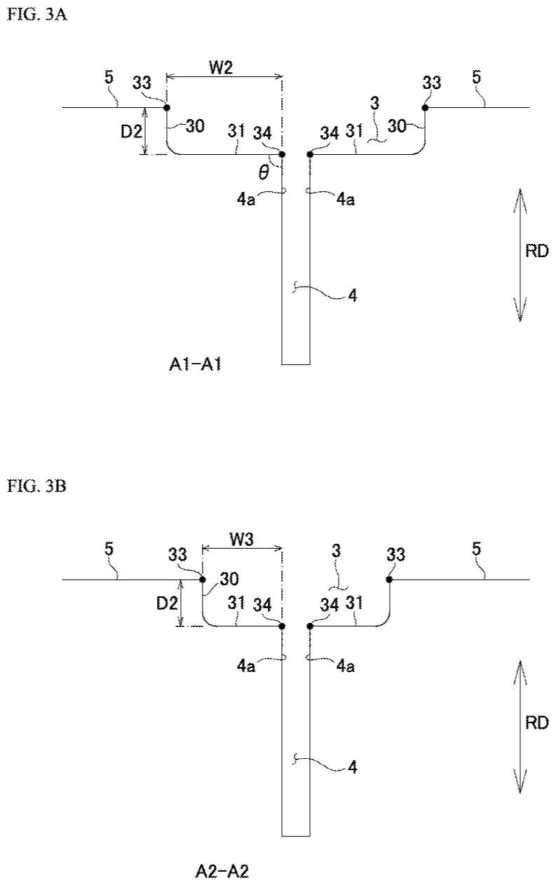

FIG. 3A and FIG. 3B are views taken along sections in the width direction of sipe 4 and recessed region 3. As shown in FIG. 3A and FIG. 3B, opening sidewall 4a which forms the opening of sipe 4 extends in the vertical direction which is parallel to the tire radial direction RD. Note that while not only opening sidewall 4a which forms the opening of sipe 4 but also the entire sidewall extends in the vertical direction in the present embodiment, there is no limitation with respect thereto. So long as opening sidewall 4a which forms the opening of sipe 4 extends in the vertical direction, the shape of the lower portion and/or the central portion of the sipe may be varied as appropriate.

As shown in FIG. 1, FIG. 2A, FIG. 3A, and FIG. 3B, formed at lug 2a is recessed region 3 which is recessed relative to contact patch surface 5. Recessed region 3 is formed to either side in the width direction of sipe 4. Recessed region 3 extends from one of two major grooves 1a, 1b so as to be directed toward the center in the tire width direction of lug 2a. While recessed region 3 is inclined with respect to both the tire width direction WD and the tire circumferential direction CD in accordance with the first embodiment, there is no limitation with respect thereto. So long as it extends so as to be inclined with respect to the tire circumferential direction CD, the direction in which recessed region 3 extends may coincide with the tire width direction WD. Recessed region 3 is such that a first end thereof opens into major groove 1, and a second end thereof terminates within the interior of lug 2a. As shown in FIG. 2A, it is preferred that length L1 in the tire width direction of recessed region 3 be 50% to 90% of length L2 in the tire width direction of lug 2a. The reason for this is that this will facilitate attainment of traction due to first edge 33 and second edge 34, as is described below.

A plurality of recessed regions 3 are provided at lug 2a which is partitioned by first major groove 1a and second major groove 1b. The plurality of recessed regions 3 comprise a plurality of first recessed regions 3a extending from first major groove 1a so as to be directed toward the center in the tire width direction of lug 2a and terminating within the interior of lug 2a, and a plurality of second recessed regions 3b extending from second major groove 1b so as to be directed toward the center in the tire width direction of lug 2a and terminating within the interior of lug 2a. As shown in FIG. 1 and FIG. 2A, the plurality of first recessed regions 3a and the plurality of second recessed regions 3b are arranged in alternating fashion along the tire circumferential direction CD.

As shown in FIG. 3A and FIG. 3B, recessed region 3 has first vertical face 30 which descends in a vertical direction (RD) from contact patch surface 5, and planar base 31 which intersects opening sidewall 4a of sipe 4. First vertical face 30 forms first edge 33 between it and contact patch surface 5. Planar base 31 and opening, sidewall 4a form second edge 34 at which the angle between planar base 31 and opening sidewall 4a is not greater than 90°. In the example at FIG. 3A and FIG. 3B, because planar base 31 extends in the horizontal direction, the angle between planar base 31 and opening sidewall 4a (angle θ at second edge 34) is 90° As a result of the fact that planar base 31 extends in the horizontal direction, it is possible to improve contact patch pressure in the vicinity of the edge as compared with the situation that would exist were planar base 31 to be inclined in such fashion as to descend toward the interior in the tire radial direction as one proceeds toward the center of recessed region 3.

As shown in FIG. 3A and FIG. 3B, standoff distances W2, W3 to first edge 33 and second edge 34 in the width direction of sipe 4 (i.e., widths W2, W3 of planar base 31 in the width direction of recessed region 3) increase as one proceeds from the center of lug 2a to the end of lug 2a. The relationship W2>W3 is satisfied. Width of recessed region 3 (width of planar base 31) may vary gradually and/or may vary in stepwise fashion.

As shown in FIG. 2A, FIG. 3A, and FIG. 3B, difference D2 in the height in the vertical direction (RD) of first edge 33 and second edge 34 is greater than or equal to 0.5 mm but is less than or equal to 1.5 mm. Furthermore, distances to first edge 33 and second edge 34 in the width direction of sipe 4 are not less than 1.5 mm. That is, W2≥1.5 mm, and W3≥1.5 mm.

Thus, because difference D2 in the height in the vertical direction of first edge 33 and second edge 34 is not greater than 1.5 mm, and because distances to first edge 33 and second edge 34 in the width direction of sipe 4 are not less than 1.5 mm, it will be possible to achieve a situation in which deformation by lug 2a when acted upon by a load is capable of causing second edge 34 to come in contact with the ground, as a result of which it will be possible to obtain a double edge effect due to action by first edge 33 and second edge 34. For example, where D2>15 mm, second edge 34 will tend not to make contact with the ground, and it will tend to be impossible to obtain an edge effect due to action by second edge 34. Furthermore, where W2 (W3)<1.5 mm, as second edge 34 will be too close to first vertical face 30, second edge 34 will tend not to make contact with the ground, and it will tend to be impossible to obtain an edge effect due to action by second edge 34. While it will be possible to obtain an edge effect due to action by first edge 33 if D2≥0.5 mm, it will tend to be impossible to obtain an edge effect due to action by first edge 33 if D2<0.5 mm.

It is preferred that standoff distances W2, W3 to first edge 33 and second edge 34 in the width direction of sipe 4 are not greater than 3.0 mm. W2≤3.0 mm, and W3≤3.0 mm. For example, where W2 (W3)>3.0 mm, recessed region 3 will be large and rigidity of lug 2a will be low, which will impair performance with respect to stability in handling. Of course, where deterioration in performance with respect to stability in handling can be tolerated, it is possible to adopt a constitution in which W2 (W3)>3.0 mm.

On a snowy road surface, there is ordinarily a tendency for the coefficient of friction μ to be low and for contact patch pressure to be low at end 20 in the tire width direction WD of lug 2a, and conversely for contact patch pressure to be high at central region 21 in the tire width direction of lug 2a. In accordance with the present embodiment, because the width of recessed region 3 increases as one proceeds from the center of lug 2a to the end of lug 2a, contact patch area at the end portion of lug 2a will be less than contact patch area toward the center, increasing contact patch pressure per unit area at the end portion of lug 2a and making it possible to achieve increased uniformity in contact patch pressure.

On the other hand, on a dry road surface, the mechanism being different from that which is responsible for the situation on a snowy road surface, there is ordinarily a tendency for contact patch pressure to be high at end 20 in the tire width direction WD of lug 2a due to the high coefficient of friction μ and the increased tendency to make contact with the ground thereat, and conversely there is a tendency for central region 21 in the tire width direction of lug 2a not to make contact with the ground and for contact patch pressure to be low thereat, which produces nonuniformity in contact patch pressure.

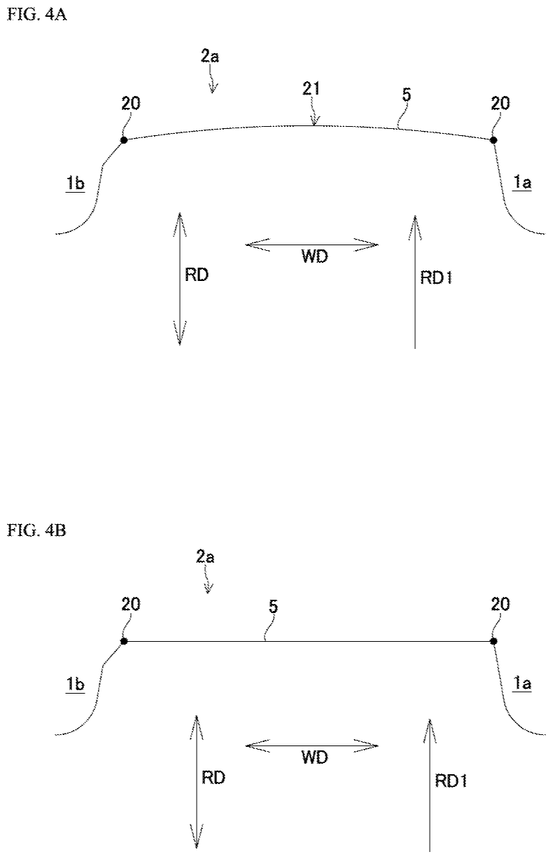

In accordance with the first embodiment, as shown in FIG. 4A, to reduce nonuniformity in contact patch pressure when on a dry road surface and to improve contact patch characteristics when on a dry road surface, lug 2a as viewed in a tire meridional section is such that central region 21 in the tire width direction protrudes toward the exterior RD1 in the tire radial direction relative to either end 20 in the tire width direction WD. The protruding shape thereof is formed from at least one curve having at least one radius of curvature. As used herein, central region 21 in the tire width direction of lug 2a refers to that region which is disposed toward the interior in the tire width direction WD from the two ends 20 in the tire width direction WD of lug 2a. The two ends 20 in the tire width direction WD of lug 2a refer to the ends thereof at contact patch surface 5. By thus causing central region 21 in the tire width direction of lug 2a to protrude beyond end(s) 20, it is possible to increase the tendency for central region 21 in the tire width direction to make contact with the ground as compared with end(s) 20 and increase contact patch pressure at central region 21 in the tire width direction when on a dry road surface, making it possible to achieve increased uniformity in contact patch pressure and improve performance with respect to stability in handling.

On the other hand, causing central region 21 in the tire width direction of lug 2a to protrude toward the exterior RD1 in the tire radial direction relative to end(s) 20 will decrease the tendency for end(s) 20 of lug 2a to make contact with the ground as compared with central region 21 in the tire width direction, which will disadvantage edge components at end(s) 20 as compared with central region 21 in the tire width direction. However, because the width of recessed region 3 is made to increase as one proceeds from the center of lug 2a to the end of lug 2a, this increases the effect of second edge 34 at end 20 of lug 2a, making it possible to ensure that there will be edge components thereat.

Of course, as shown in FIG. 4B, where there is no intention to improve contact patch characteristics when on a dry road surface such as might be the case not with an all-season tire but with a studless tire, lug 2a as viewed in a tire meridional section need not be such that central region 21 in the tire, width direction protrudes toward the exterior RD1 in the tire radial direction relative to either end 20 in the tire width direction WD, it being possible for the region between ends 20 in the tire width direction of lug 2a to be flat.

### Working Examples

Working examples and the like which illustrate the constitution and effect of the present disclosure in specific terms are described below.

### Performance With Respect to Traction in Snow

Tires in accordance with the following Comparative Examples and Working Examples were mounted on an actual vehicle, and evaluation was carried out with respect to the subjective feeling experienced by the driver, with results being expressed in terms of an index. The higher the index the more excellent the result. Results are shown as indexed relative to a value of 100 for the value obtained at Comparative Example 1.

To compare the effect of the width of recessed region 3, testing was carried out in accordance with Comparative Examples 1 through 2 and Working Examples 1 through 3.

### Comparative Example 1

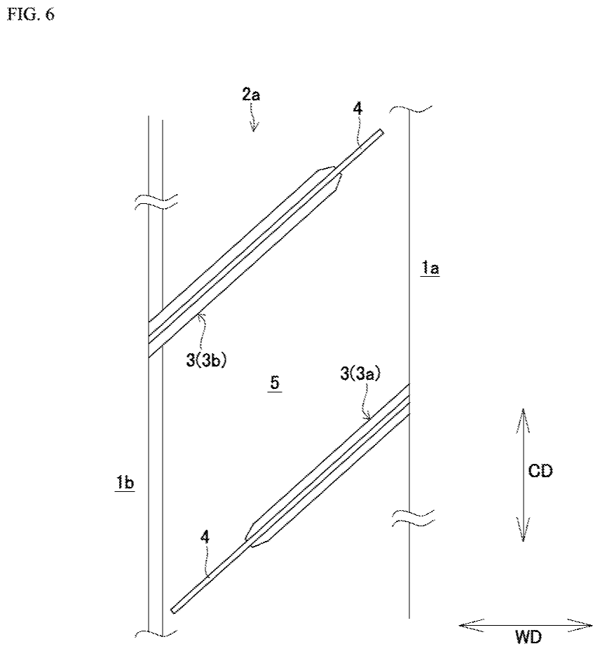

Width of recessed region 3 (width of planar base 31) was uniform as shown in FIG. 6, and depth D2 of recessed region 3 was uniform as shown in FIG. 3A. Depth (D2) of recessed region 3 was 1.0 mm, and width W2 (W3) of recessed region 3 was 1.4 mm.

### Working Example 1

Depth (D2) of recessed region 3 was 1.0 mm, and width W2 (W3) of recessed region 3 was 1.5 mm. In other respects, it was similar to Comparative Example 1.

### Working Example 2

Depth (D2) of recessed region 3 was 1.0 mm, and width W2 (W3) of recessed region 3 was 2.0 mm. In other respects, it was similar to Comparative Example 1.

### Working Example 3

Depth (D2) of recessed region 3 was 1.0 mm, and width W2 (W3) of recessed region 3 was 3.0 mm. In other respects, it was similar to Comparative Example 1.

### Comparative Example 2

Depth (D2) of recessed region 3 was 1.0 mm, and width W2 (W3) of recessed region 3 was 3.1 mm. In other respects, it was similar to Comparative Example 1.

To compare the effect of the depth of recessed region 3, testing was carried out in accordance with Comparative Examples 3 through 4 and Working Examples 4 through 6.

### Comparative Example 3

Depth (D2) of recessed region 3 was 0.4 mm, and width W2 (W3) of recessed region 3 was 1.5 mm. In other respects, it was similar to Comparative Example 1.

### Working Example 4

Depth (D2) of recessed region 3 was 0.5 mm, and width W2 (W3) of recessed region 3 was 1.5 mm. In other respects, it was similar to Comparative Example 1.

### Working Example 5

Depth (D2) of recessed region 3 was 1.0 mm, and width W2 (W3) of recessed region 3 was 1.5 mm. In other respects, it was similar to Comparative Example 1.

### Working Example 6

Depth (D2) of recessed region 3 was 1.5 mm, and width W2 (W3) of recessed region 3 was 1.5 mm. In other respects, it was similar to Comparative Example 1.

### Comparative Example 4

Depth (D2) of recessed region 3 was 1.6 mm, and width W2 (W3) of recessed region 3 was 1.5 mm. In other respects, it was similar to Comparative Example 1.

TABLE 1

| | Comparative | Working | Working | Working | Comparative | Comparative | Working | Working | Working | Comprative |
|---|---|---|---|---|---|---|---|---|---|---|
| | Example 1 | Example 1 | Example 2 | Example 3 | Example 2 | Example 3 | Example 4 | Example 5 | Example 6 | Example 4 |
| Depth of recessed | 1.0 | 1.0 | 1.0 | 1.0 | 1.0 | 0.4 | 0.5 | 1.0 | 1.5 | 1.6 |
| region [mm] | | | | | | | | | | |
| Width of recessed | 1.4 | 1.5 | 2.0 | 3.0 | 3.1 | 1.5 | 1.5 | 1.5 | 1.5 | 1.5 |
| region [mm] | | | | | | | | | | |
| Performance with | 100 | 102 | 102 | 102 | 100 | 100 | 102 | 102 | 102 | 100 |
| respect to traction | | | | | | | | | | |
| in snow | | | | | | | | | | |

Based on the results in TABLE 1, regarding width W2 (W3) of recessed region 3, it can be understood that performance with respect to traction in snow cannot be achieved unless width W2 (W3) of recessed region 3 is greater than or equal to 1.5 mm but is less than or equal to 3.0 mm. It is thought that this may be due to the fact that second edge 34 tends not to make contact with the round, and it tends to be impossible to obtain an edge effect due to, action by second edge 34, when width W2 (W3)<1.5 mm. And it is thought that this may be due to the fact that contact with the ground by planar base 31 tends to increase due to application of a load thereon, and it tends to be impossible to obtain an edge effect due to action by second edge 34, when width W2 (W3)>3.0 mm.

Regarding depth D2 of recessed region 3, it can be understood that performance with respect to traction in snow cannot be achieved unless depth D2 of recessed region 3 is greater than or equal to 0.5 mm but is less than or equal to 1.5 mm. It is thought that this may be due to the fact that it tends to be impossible to obtain an edge effect due to action by first edge 33 when D2<0.5 mm; and due to the fact that second edge 34 tends not to make contact with the ground, and it tends to be impossible to obtain an edge effect due to action by second edge 34, when D2>1.5 mm.

### Variations

Whereas in the example shown in FIG. 1 and FIG. 2A the first end of sipe 4 a opens into major groove 1 and the second end thereof terminates within the interior of lug 2a, there is no limitation with respect thereto. For example, both the first end and the second end of sipe 4 a may open into major groove 1. Furthermore, whereas in accordance with the first embodiment the direction in which sipe 4 extends is such that it is inclined with respect to both the tire width direction WD and the tire circumferential direction CD, there is no limitation with respect thereto. So long as it extends so as to be inclined with respect to the tire circumferential direction CD, the direction in which sipe 4 extends may coincide with the tire width direction WD.

Whereas in accordance with the first embodiment the first recessed regions 3a and the second recessed regions 3b are arranged in alternating fashion along the tire circumferential direction CD, there is no limitation with respect thereto. The first recessed regions 3a and the second recessed regions 3b need not be arranged in alternating fashion along the tire circumferential direction CD. Furthermore, whereas both first recessed regions 3a and second recessed regions 3b are arranged at lug 2a, there is no limitation with respect thereto. An example in which first recessed regions 3a are formed at the lug but second recessed regions 3b are not formed thereat may be cited as example. Similarly, an example in which second recessed regions 3b are formed at the lug but first recessed regions 3a are not formed thereat may be cited.

Moreover, whereas first recessed regions 3a and second recessed regions 3b are inclined in the same direction with respect to the tire width direction, there is no limitation with respect thereto. First recessed regions 3a and second recessed regions 3b may be inclined in mutually opposite directions.

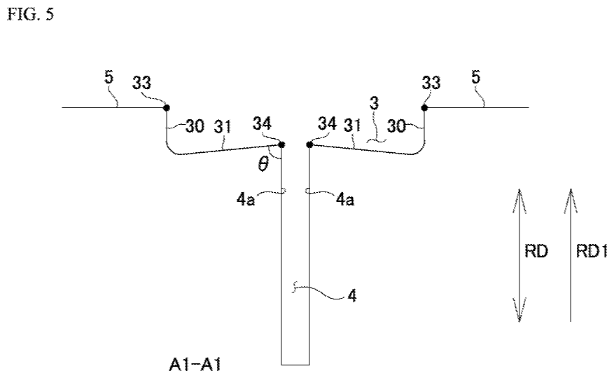

Furthermore, whereas, in accordance with the first embodiment, planar base 31 extends in the horizontal direction, there is no limitation with respect thereto. For example as shown in FIG. 5, planar base 31 may be inclined in such fashion that the height thereof increases so as to be increasingly directed toward the exterior RD1 in the tire radial direction as one proceeds toward the center in the width direction of recessed region 3 as viewed in a section taken along the width direction of recessed region 3. Where this is the case, the angle between planar base 31 and opening sidewall 4a (the angle at second edge 34) will be less than 90°. By thus causing the angle at second edge 34 to be less than 90°, because this will increase the surface area of recessed region 3 (planar base 31), it will be possible to improve performance with respect to dissipation of heat.

Whereas in accordance with the first embodiment the width of recessed region 3 (the width of planar base 31) increases as one proceeds from the center of lug 2a to the end of lug 2a, there is no limitation with respect thereto. For example as shown in FIG. 6, width of recessed region 3 (width of planar base 31) may be constant.

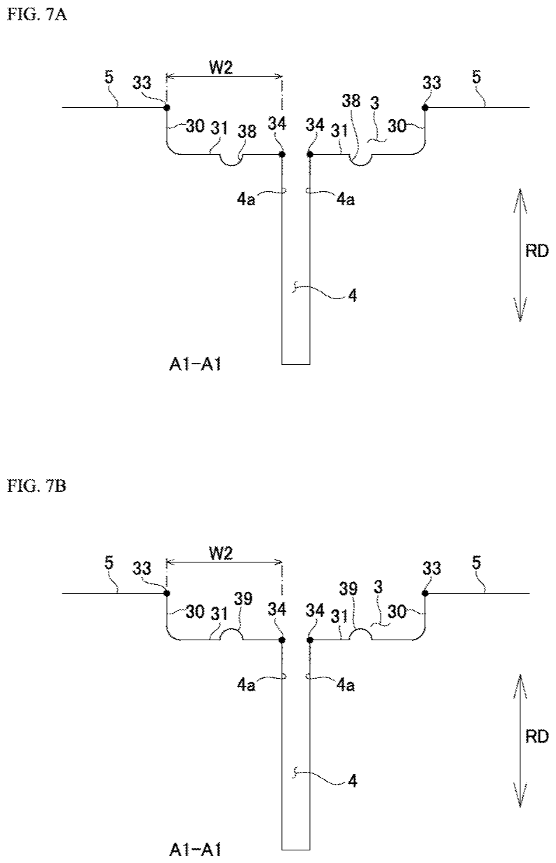

Furthermore, whereas, in accordance with the first embodiment, planar base 31 is a flat surface, there is no limitation with respect thereto. For example as shown in FIG. 7A, one or more dimples 38 of width less than width W2 of planar base 31 may be formed at planar base 31. Or in another example as shown in FIG. 7B, one or more protrusions 39 of width less than width W2 of planar base 31 may be formed at planar base 31.

At the embodiment shown in FIG. 1, the lug(s) 2a to which the present disclosure may be applied are not limited to mediate lug(s) 2a. For example, the present disclosure may be applied to center lug(s) 2b, to other mediate lug(s) 2c, and/or to shoulder lug(s) 2d.

As described above, a pneumatic tire in accordance with the first embodiment comprises a lug 2a that is partitioned by at least one major groove (1a, 1b) and that forms a contact patch surface 5; a sipe 4 that extends from the at least one major groove 1a [1b] so as to be directed toward a center in a tire width direction of the lug 2a, the sipe 4 having an opening sidewall 4a extending in a vertical direction (RD); and a recessed region 3 that is formed to either side in a width direction of the sipe 4 and that is recessed relative to the contact patch surface 5. The recessed region 3 has a vertical face 30 that forms a first edge 33 between the vertical face 30 and the contact patch surface 5, and has a planar base 31 that intersects the opening sidewall 4a of the sipe 4. The planar base 31 and the opening sidewall 4a of the sipe 4 forming a second edge 34 at which the angle θ between the planar base 31 and the opening sidewall 4a is not greater than 90°. Difference in height in the vertical direction of the first edge and the second edge is greater than or equal to 0.5 mm but is less than or equal to 1.5 mm. Distances to the first edge and the second edge in the width direction of the sipe are not less than 1.5 mm.

Thus, recessed region 3 is firmed to either side in the width direction of sipe 4 formed at lug 2a, recessed region 3 being formed from vertical face 30 and planar base 31. Because first edge 33 is formed between contact patch surface 5 and vertical face 30 that extends in parallel fashion with respect to the vertical direction which is parallel to the tire radial direction RD, an edge effect due to action by first edge 33 is exhibited. Furthermore, because second edge 34 is formed between planar base 31 and opening sidewall 4a of sipe 4, and because angle θ of second edge 34 is not greater than 90°, an edge effect due to action by second edge 34 is exhibited. Moreover, because difference D2 in the height in vertical direction RD of first edge 33 and second edge 34 is not greater than 1.5 mm, and because distances to first edge 33 and second edge 34 in the width direction of sipe 4 are not less than 1.5 mm, it will be the case that deformation by lug 2a when acted upon by a load will cause second edge 34 to be made capable of coming in contact with the ground, as a result of which it will be possible to obtain a doubling of edge effect due to action by first edge 33 and second edge 34, and it will be possible to improve performance with respect to traction in snow. Because difference D2 in the height in the vertical direction (RD) of first edge 33 and second edge 34 is not less than 0.5 mm, it will be possible to obtain an edge effect due to action by first edge 33.

Accordingly, because two edge effects will be exhibited per side in the width direction of sipe 4, and four edge effects will be exhibited at both sides in the width direction of sipe 4, it will be possible to improve performance with respect to traction in snow.

As is the case in the embodiment shown in FIG. 3A and FIG. 3B, it is preferred that standoff distance(s) W2 (W3) to first edge 33 and to second edge 34 in the width direction of sipe 4 be not greater than 3.0 mm.

If the foregoing standoff distance(s) W2 (W3) exceed 3.0 mm, the increased size of recessed region 3 will result in reduced rigidity at lug 2a, which will impair performance with respect to stability in handling when on a dry road surface. Accordingly, adoption of the foregoing constitution will make it possible to suppress and/or prevent impairment of performance with respect to stability in handling.

As is the case in the embodiment shown in FIG. 2A, FIG. 3A and FIG. 3B, it is preferred that standoff distances W2 (W3) to the first edge 33 and the second edge 34 in the width direction of the sipe 4 increase as one proceeds from a center of the lug 2a to an end of the lug 2a.

On a snowy road surface, there is ordinarily a tendency for the coefficient of fiction μ to be low and for contact patch pressure to be low at end 20 in the tire width direction WD of lug 2a, and conversely for contact patch pressure to be high at central region 21 in the tire width direction of lug 2a. In accordance with the embodiment shown in FIG. 2A, FIG. 3A, and FIG. 3B, because the foregoing standoff distance(s) (width(s) of recessed region 3) increase as one proceeds from the center of lug 2a to the end of lug 2a, contact patch area at the end portion of lug 2a will be less than contact patch area toward the center, increasing contact patch pressure per unit area at the end portion of lug 2a and making it possible to achieve increased uniformity in contact patch pressure.

As is the case in the embodiment shown in FIG. 4A, it is preferred that the lug 2a as viewed in a tire meridional section is such that a central region 21 in the tire width direction protrudes toward an exterior in a tire radial direction (RD) relative to either end 20 in the tire width direction (WD). Furthermore, as is the case in FIG. 2A, it is preferred that standoff distances W2 (W3) to the first edge 33 and the second edge 34 in the width direction of the sire 4 increase as one proceeds from a center of the lug 2a to an end of the lug 2a.

Thus, causing central region 21 in the tire width direction of lug 2a to protrude toward the exterior RD1 in the tire radial direction relative to end(s) 20 will decrease the tendency for end(s) 20 of lug 2a to make contact with the ground as compared with central region 21 in the tire width direction, which will disadvantage edge components at end(s) 20 as compared with central region 21 in the tire width direction. However, because the width of recessed region 3 is made to increase as one proceeds from the center of lug 2a to the end of lug 2a, this increases the effect of second edge 34 at end 20 of lug 2a, making it possible to ensure that there will be edge components thereat. Accordingly, it will be possible to simultaneously achieve improvement in both traction in snow as well as in performance with respect to stability in handling when on a dry road surface.

As is the case in the embodiment shown in FIG. 7A and FIG. 7B, it is preferred that one or more dimples 38 and/or protrusions 39 of width less than width W2 of the planar base 31 are funned at the planar base 31.

As a result of adoption of this constitution, because edge effects will be exhibited not only due to action by first edge 33 and second edge 34 but also due to action by dimples 38 and/or protrusions 39, it will be possible to further improve performance with respect to traction in snow.

As described above, a pneumatic tire in accordance with the first embodiment comprises a lug 2a that is partitioned by a first major groove 1a and a second major groove 1b, and that forms a contact patch surface 5; a plurality of first recessed regions 3a that extend from the first major groove 1a, so as to be directed toward a center in a tire width direction of the lug 2a, that terminate within an interior of the lug 2a, and that are recessed relative to the contact patch surface 5; and a plurality of second recessed regions 3b that extend from the second major groove 1b so as to be directed toward the center in the tire width direction of the lug 2a, that terminate, within the interior of the lug 2a, and that are recessed relative to the contact patch surface 5. The lug 2a is such that a central region thereof in the tire width direction protrudes relative to either end 20 thereof in the tire width direction WD. The plurality of first recessed regions 3a and the plurality of second recessed regions 3b are arranged in alternating fashion along a tire circumferential direction CD. The respective recessed regions 3 each has a vertical face 30 that descends in a vertical direction (RD) from the contact patch surface 5, and a planar base 31 that extends in a width direction of the each recessed region 3. The planar base 31 is horizontal, or is inclined in such fashion that a height thereof increases so as to extend further toward an exterior RD1 in a tire radial direction as one proceeds toward a center of the each recessed region 3 as viewed in a section taken along the width direction of the each recessed region 3. Width W2 (W3) of the planar base 31 increases as one proceeds from the center in the width direction of the lug 2a to an end of the lug 2a.

In accordance with this constitution, because lug 2a is such that central region 21 in the tire width direction protrudes toward the exterior RD1 in the tire radial direction relative to end(s) 20 in the tire width direction, there will be increased tendency for central region 21 in the tire width direction to make contact with the ground as compared with end(s) 20, increasing contact patch pressure at central region 21 in the tire width direction when on a dry road surface, this being in a direction such as will permit increase in uniformity in contact patch pressure, which will make it possible to improve performance with respect to stability in handling. And yet, if the amount by which this protrudes relative thereto is excessive, this will disturb the balance in contact patch pressure. In this regard, because the width of planar base 31 (recessed region 3) at the end of lug 2a is formed so as to be greater than the width of planar base 31 (recessed region 3) at a location toward the center of the lug, this will increase contact patch pressure at end(s) 20 in the tire width direction of lug 2a as compared with central region 21 in the tire width direction of lug 2a, making it possible to achieve balance in contact patch pressure between the central portion and the end(s), as a result of which performance with respect to stability in handling when on a dry road surface will be improved.

Furthermore, because planar base 31 is horizontal, or is inclined in such fashion that the height thereof increases so as to extend further toward the exterior RD1 in the tire radial direction as one proceeds toward the center of recessed region 3 as viewed in a section taken along the width direction of recessed region 3, it will be possible to suppress occurrence of a situation in which excessive size of recessed region 3 causes reduced rigidity at lug 2a and impairment of performance with respect to stability in handling when on a dry road surface.

At the same time, because lug 2a is such that central region 21 in the tire width direction protrudes beyond the two ends 20 in the tire width direction, it will be possible improve performance with respect to water shedding.

As is the case in the embodiment shown in FIG. 3A and FIG. 3B, it is preferred that the tire further comprising a first edge 33 formed by the contact patch surface 5 and the vertical face 30, difference D2 in height in the vertical direction (RD) of the planar base 31 and the first edge 33 is greater than or equal to 0.5 mm but is less than or equal to 1.5 mm.

Within this numerical range, it will be possible to properly suppress occurrence of a situation in which excessive size of recessed region 3 causes reduced rigidity at lug 2a and impairment of performance with respect to stability in handling when on a dry road surface.

As is the case in the present embodiment, a sipe 4 is formed at the central region of the each recessed region 3.

In accordance with this constitution, edge effects are exhibited due to action by sipes 4, making it possible to improve performance with respect to traction. Moreover, sipes 4 facilitate conformability of lug 2a and the tendency for contact with the ground to occur, making it possible to improve performance with respect to traction and performance with respect to braking.

While embodiments in accordance with the present disclosure have been described above with reference to the drawings, it should be understood that the specific constitution thereof is not limited to these embodiments. The scope of the present disclosure is as indicated by the claims and not merely as described at the foregoing embodiments, and moreover includes all variations within the scope of or equivalent in meaning to that which is recited in the claims.

Structure employed at any of the foregoing embodiment(s) may be employed as desired at any other embodiment(s). The specific constitution of the various components is not limited only to the foregoing embodiment(s) but admits of any number of variations without departing from the gist of the present disclosure.

1. A pneumatic tire comprising:
a lug that is partitioned by at least one major groove and that forms a contact patch surface;
a sipe that extends from the at least one major groove so as to be directed toward a center in a tire width direction of the lug, the sipe having an opening sidewall extending in a vertical direction; and
a recessed region that is formed to either side in a width direction of the sipe and that is recessed relative to the contact patch surface;
wherein the recessed region has a vertical face that forms a first edge between the vertical face and the contact patch surface, and has a planar base that intersects the opening sidewall of the sipe, the planar base and the opening sidewall of the sipe forming a second edge at which the angle between the planar base and the opening sidewall is not greater than 90°;
wherein difference in height in the vertical direction of the first edge and the second edge is greater than or equal to 0.5 mm but is less than or equal to 1.5 mm; and
wherein distances to the first edge and the second edge in the width direction of the sipe are not less than 1.5 mm.

2. The pneumatic tire according to claim 1 wherein standoff distances to the first edge and the second edge in the width direction of the sipe are not greater than 3.0 mm.

3. The pneumatic tire according to claim 1 wherein standoff distances to the first edge and the second edge in the width direction of the sipe increase as one proceeds from a center of the lug to an end of the lug.

4. The pneumatic tire according to claim 3 wherein the lug as viewed in a tire meridional section is such that a central region in the tire width direction protrudes toward an exterior in a tire radial direction relative to either end in the tire width direction.

5. The pneumatic tire according to claim 1 wherein one or more dimples and/or protrusions of width less than width of the planar base are formed at the planar base.
